(19) United States
(12) Patent Application Publication
(10) Pub. No.: US 2026/0253468 A1
(43) Pub. Date: Aug. 27, 2026

(54) Gate Arrangement, In Particular, For A Passenger Transport System

(71) Applicants: Gion Timmermann, Mönchengladbach (DE); Henning Heinen, Baesweiler (DE)

(72) Inventors: Gion Timmermann, Mönchengladbach (DE); Henning Heinen, Baesweiler (DE)

(73) Assignee: Scheidt & Bachmann GmbH, Mönchengladbach (DE)

(21) Appl. No.: 19/450,162

(22) Filed: Jan. 15, 2026

(30) Foreign Application Priority Data
Feb. 25, 2025 (DE) 10 2025 106 970.0

(51) Int. Cl. G07C 9/20; E05F 15/60

(52) U.S. Cl. CPC G07C 9/20; E05F 15/60; E05Y 2201/21; E05Y 2900/40

(57) ABSTRACT

A gate arrangement includes a gate with a first gate body and second gate body adjacent the first gate body, and a blocking element movable by an actuator of the gate between an open and closed position. An actuator control equipment controls the actuator. The actuator control equipment controls the actuator to generate an actuating force counteracting the external force up to a maximum permissible actuating force when an external force acts onto the blocking element. An occupancy status detection equipment detects an occupancy status of the gate at a control area side of the blocking element and/or at a non-control area side of the blocking element. A force detection equipment detects a force parameter causing the actuating force. The actuating force counteracts the acting external force. The actuator control equipment adjusts the maximum permissible actuating force of the actuator based on the detected force parameter and detected occupancy status.

### CROSS-REFERENCE TO RELATED PATENT APPLICATION

This patent application claims the benefit of priority to German Patent Application No. 10 2025 106 970.0 filed Feb. 25, 2025, the entire teachings and disclosures of which are incorporated herein by reference thereto.

### FIELD OF THE INVENTION

The invention relates to a gate arrangement, in particular, for a passenger transport system, comprising at least one gate having a first gate body and a second gate body arranged adjacent to the first gate body, wherein the first gate body and the second gate body define a passageway between a control area and an non-control area, and at least one blocking element movable between an open position and a closed position by at least one actuator of the gate, an actuator control equipment configured to control the actuator in such a way that the actuator moves the blocking element into a predefined position, wherein the actuator control equipment is configured to control the actuator in such a way that, if at least one external force acts onto the blocking element, the actuator generates an actuating force counteracting the external force up to a maximum permissible actuating force. Furthermore, the invention relates to a method, a computer program, and a passenger transport system.

### BACKGROUND OF THE INVENTION

Access control systems and gate arrangements, respectively, for controlling an access from an uncontrolled area to a controlled area and/or in the opposite direction are used, for example, in passenger transport systems.

A present passenger transport system, in particular, a public passenger transport system, is used to transport passengers respectively users by means of passenger transport vehicles (hereinafter referred to as transport vehicles). Examples of transport vehicles in a passenger transport system include rail vehicles (e.g., suburban trains, subways, trams, etc.), motor vehicles (e.g., buses), but also watercrafts (e.g., ferries) and aircrafts. However, gate arrangements are also used in other applications where users' authorization for an entering or leaving a controlled area respectively control area is to be checked, such as at sporting events, cultural events, or leisure events.

In the present disclosure, a gate arrangement comprises at least one gate. A gate (also referred to as a passage barrier) is configured to selectively block and selectively allow an entering (i.e., in particular, stepping in) from a first area to a second area. A gate can be used, in particular, to ensure that only authorized or eligible users can pass through the gate, for example, to enter and/or leave the control area. Interactions between the gate arrangement and the user are necessary for a user to use a gate arrangement.

A gate arrangement is configured to check a ticket medium of a user respectively the access authorization of a user provided on it before a releasing of a passing through a gate. A gate can comprise at least one reading module respectively ticket one detecting equipment. Known reading modules include optical reading modules, in particular, configured to detect images of a graphic ticket code (e.g., barcode or QR code) of a ticket medium in a detection area of the reading module. A user may have a ticket medium with an access authorization readable by the reading module, for example, encoded in a ticket code (e.g., a ticket code such as a magnetic stripe code, graphic ticket code such as a barcode or QR code, RFID identifier, another readable user identifier or mobile device identifier, etc.). The ticket code can contain as data content at least the access authorization of the user and/or an identification of the user, which can be used to check the access authorization.

In an initial state, a gate is usually blocked respectively in a blocked state. This means, in particular, that a blocking element of the gate physically prevents a user from going through the gate. The blocking element is in a closed position and is in a closed state. In other cases, the gate may be open in the initial state and only close if a user without a valid access authorization respectively a valid ticket medium attempts to pass through the gate.

Without limiting the generality of the foregoing, it is assumed below that a gate is blocked in an initial state and is in the closed state. The closed state is also referred to as the non-validated state. In particular, in the closed state, there is no positive validation check of a ticket medium of a user. In the closed state of the blocking element respectively gate, the at least one blocking element is in the closed position respectively is held in the closed position by at least one actuator or is moved from an open position to the closed position and, in particular, blocks a going through of a gate by a user.

The gate arrangement comprises an actuator control equipment configured to control an actuator of the gate in such a way that the actuator moves the blocking element into a predefined position, in particular, into the open position or the closed position, for example, depending on a validation check.

A positive validation check of a ticket medium of a user causes that the gate respectively the blocking element is set to the open state. In this open state respectively validated state of the blocking element, the blocking element is moved by an actuator from the closed position to the open position to allow the user to go through. In particular, the detected ticket medium respectively the read access authorization of the detected ticket medium can be checked by a validation module of the gate arrangement and/or a background system communicatively connected to the gate arrangement.

If the validation check result is positive, i.e., if it is determined that the ticket medium is a valid ticket medium respectively contains a valid access authorization (in particular, in the form of a valid validation date), the corresponding gate can be released by moving the at least one blocking element into the open position by means of an actuator, as described above. If the validation check result is negative, i.e., if it is determined that the ticket medium is an invalid ticket medium respectively contains an invalid access authorization (in particular, in the form of an invalid validation date), the corresponding gate can remain blocked by holding the at least one blocking element in the closed respectively blocked position by the at least one actuator. The blocking element remains in the closed state.

In the prior art, the actuator control equipment is configured to control the actuator in such a way that, if at least one external force acts onto the blocking element, the actuator generates an actuating force counteracting the external force up to a maximum permissible actuating force.

In particular, for safety reasons, in a gate arrangement in which the at least one blocking element is in a blocking position when closed, it may be provided that, if a sufficiently large external force is applied to the at least one blocking element, the gate can be set from the closed position to an at least partially open position while the blocking element respectively gate is in the closed or non-validated state. This means that the at least one blocking element is (partially) opened, but not by the at least one actuator provided for this purpose (e.g., a motor), but by a manually applied force corresponding to the actuating force applied by the actuator if the applied external force exceeds the maximum permissible actuating force.

In particular, an actuator can apply an actuating force in the form of a counterforce against the manually applied force, wherein in the prior art the maximum permissible actuating force of the actuator is fixed, for example, due to a technical limitation of the actuator. If the amount of the externally applied force exceeds the maximum permissible actuating force of the actuator, then the at least one blocking element can be (manually) moved.

For safety reasons, in some countries it is required that a gate is to be opened with a breakthrough force in order to provide users respectively passengers with an escape route through the at least one gate of the gate arrangement, in particular, in an emergency situation such as a panic. By applying a breakthrough force greater than the specified maximum permissible actuating force of the actuator to the at least one blocking element, users are able to leave the control area, e.g., a station for transport vehicles, through the at least one gate in the event of an emergency.

It may be provided that the necessary external breakthrough forces for opening the at least one blocking element are set differently depending on the direction of passage (i.e., in the direction of the control area from the non-control area and in the direction of the non-control area from the control area). In other words, different maximum permissible actuator forces may be predefined depending on the direction in which a breakthrough force is manually applied to a blocking element.

By this, in the prior art it is attempted to make an unauthorized entering into the control area more difficult, while in an emergency situation, an exiting from the control area should be made easier. However, the problem with this is that an unauthorized user who is at the non-control area side and pulls at least one blocking element in the direction of the non-control area only has to apply the lower breakthrough force (which is actually only intended for the opposite direction). It is also possible that a user who is at the control area side could push the blocking element in the closed state to allow a further unauthorized user who is at the non-control area side to enter the control area.

In principle, therefore, a gate arrangement is subject to the following conflicting requirements:
The breakthrough force (respectively maximum permissible actuator force) in the direction of the control area should be as high as possible in order to prevent an unauthorized entering into the control area (e.g., unauthorized use of a transport vehicle) by breaking through the gate.
The breakthrough force (respectively maximum permissible actuator force) in the direction of the non-control area should be reduced, in particular, minimized, in order to allow a user to easily leave the control area (e.g., into the open air) in the event of an emergency.

In known gate arrangements, the maximum permissible actuator force with which a blocking element can be held in the closed position by an actuator is a static respectively predefined value that is often the same for the exit and entrance directions. The choice of the value of the maximum permissible actuating force of the actuator of a blocking element respectively gate is subject to a conflict of objectives between low values as an additional safety function in the event of an emergency and high values to prevent fraud (an important performance indicator for gates). As already described, it is known in the prior art for gates to predefine different maximum permissible actuator forces in the exit direction and entrance direction, which, however, do not improve security against manipulation, but can in some cases reduce it even further, as explained above.

### SUMMARY OF THE INVENTION

Therefore, it is the object of the invention to provide a gate arrangement which at least partially reduces the disadvantages of the prior art and, in particular, simultaneously makes an unauthorized entering into a control area more difficult and facilitates an exiting from the control area in an emergency situation.

According to a first aspect of the invention, this object is solved by a gate arrangement according to claim 1. The gate arrangement is intended, in particular, for use in a passenger transport system. The gate arrangement comprises at least one gate. The at least one gate comprises a first gate body and a second gate body arranged adjacent to the first gate body. The first gate body and the second gate body define a passageway between a control area and a non-control area. The gate comprises at least one blocking element movable between an open position and a closed position by at least one actuator of the gate. The gate arrangement comprises an actuator control equipment. The actuator control equipment is configured to control the actuator in such a way that the actuator moves the blocking element into a predefined position. The actuator control equipment is configured to control the actuator in such a way that, if at least one external force acts onto the blocking element, the actuator generates an actuating force counteracting the external force up to a maximum permissible actuating force. The gate arrangement comprises at least one occupancy status detection equipment. The occupancy status detection equipment is configured to detect an occupancy status of the gate at a control area side of the blocking element and/or at a non-control area side of the blocking element. The gate arrangement comprises at least one force detection equipment. The force detection equipment is configured to detect at least one force parameter causing the actuating force, wherein the actuating force counteracts the external force acting on it. The at least one actuator control equipment is configured to adjust the maximum permissible actuating force of the actuator based on the at least one detected force parameter and the detected occupancy status.

In contrast to the prior art, according to the invention, by providing that the maximum permissible actuating force of the actuator of a gate, with which the at least one blocking element can be held in the closed position by at least one actuator (e.g., during a closed state of the gate), is dynamically adjustable depending on the (current) situation (e.g., emergency situation, fraud situation, etc.) at the gate, which can be derived at least from the at least one detected force parameter and the at least one detected occupancy status of the gate, the disadvantages of the prior art are at least partially reduced and, in particular, an unauthorized entering into a control area is made more difficult at the gate arrangement and, in an emergency situation, an exiting from the control area is made easier. The invention thus makes it possible to determine, in particular, to estimate, from the at least one detected force parameter and the at least one detected occupancy status, whether an external force is being applied to a blocking element for the purpose of fraud or escape (due to an emergency situation). Depending on this, the value of the maximum permissible actuating force of the actuator can be dynamically adjusted, in particular, minimized or maximized.

The gate arrangement according to the invention is preferably used in a passenger transport system (but also in other applications in which the authorization of users to enter or leave a controlled area is to be monitored, such as at sporting events, cultural events, or leisure events) in order, in particular, to separate a controlled area respectively control area of the passenger transport system from an uncontrolled area respectively non-control area of the passenger transport system. A passenger transport system according to the invention is, in particular, a public passenger transport system and is used to transport persons respectively users by means of passenger transport vehicles (hereinafter referred to as transport vehicles). Examples of transport vehicles include, but are not limited to, rail vehicles (e.g., trains, subways, trams, etc.), motor vehicles (e.g., buses), but also watercrafts (e.g., ferries) and aircrafts. The control area is, in particular, a train station, a bus stop, etc.

The gate arrangement according to the invention comprises at least one gate, preferably two or more gates respectively passage barriers, which are, in particular, arranged adjacent to each other.

A gate comprises (for example, exactly) two gate bodies. Two gates arranged adjacent to each other can (always) share a gate body. A gate body is, in particular, a base of a gate arrangement extending in the direction of passage. The two gate bodies of a passage barrier are, in particular, arranged parallel to each other. The area between the gate bodies, which is defined respectively formed by the gate bodies, is, in particular, a passageway from the control area to the non-control area and/or from the non-control area to the control area. The passageway comprises a passageway area. The two gate bodies of a passage barrier form the side boundaries of the passageway of this gate.

A gate arrangement according to the invention can be arranged, in particular, at an entrance and/or exit of a control area. The control area can, in particular, require an access authorization respectively stay authorization of a user for access respectively staying.

A (respective) gate preferably comprises at least one reading module. The at least one reading module may be arranged in respectively on a (defined) gate body of the (respective) gate. For example, the respective gate body of a respective gate arranged on the right-hand side in the direction of passage may comprise the reading module (in particular, in the area of the front side of the gate body).

For example, the at least one reading module may be a Bluetooth reading module, RFID reading module, NFC reading module, WLAN reading module, optical reading module, magnetic strip scanner, and/or the like.

The at least one reading module of a gate may preferably be an NFC reading module and/or an optical reading module (e.g., barcode scanner or QR code scanner) configured to detect a ticket code of a ticket medium held within the detection area respectively range of the reading module. The range of a reading module in the form of an NFC reading module and/or an optical reading module can be between almost 0 and 20 cm, in particular, between almost 0 and 10 cm.

The ticket medium can be a mobile device on which a ticket code (containing at least one access authorization as data content) can be stored in a readable form. For example, a graphical ticket code can be displayed on the display of the mobile device. Alternatively or additionally, a stored ticket code can be readable by means of an NFC interface of the mobile device.

Examples of mobile devices include, but are not limited to, smartphones, tablet computers, mobile game consoles, laptops, netbooks, smart watches, and similar wearables.

However, the ticket medium is not limited to a mobile device, but can also be another ticket medium, such as a paper-based ticket medium or card-based ticket medium, for example, with a graphic ticket code located, in particular, printed, on the outside, or with a magnetic strip. Other examples of ticket media that can be read by a reading module include tokens, chip cards (or smart cards), credit cards, bank cards (or similar), mobile phones, personal digital assistants (PDAs), tablet PCs, integrated circuit chips, electronic passports, electronic ID documents, etc.

A gate according to the invention comprises at least one blocking element. In particular, at least one blocking element can be attached to at least one gate body of a (respective) gate. In particular, each gate can comprise at least one (controllable) actuator respectively drive (e.g., an electric motor) configured to move the blocking element between an open position and a closed position.

The gate arrangement comprises an actuator control equipment configured to control the actuator in such a way that the actuator moves the blocking element into a predefined position, for example, into an open position or a closed position.

A moving of the blocking element into the open position by means of an actuator can, in particular, be carried out in a permissible manner (only) during the open state respectively validated state of the blocking element respectively gate. In the open position and in the open state, passage through the gate is permitted. An open state respectively validated state in this context means, in particular, a state in which a user is authorized to go through the gate (based on his positively verified ticket medium). After a (detected) passaging through the gate, the gate respectively the blocking element can be returned to the closed state and the blocking element can then be moved to the closed position. In particular, a positive validation check of the ticket medium is present in the open state.

During a closed respectively non-validated state of the blocking element respectively the gate, a going through the gate is (physically) blocked, in particular, by the blocking element being in the closed position respectively being moved into this position. A closed state respectively non-validated state in this case means, in particular, a state in which a user is not authorized to go through the gate (for example, because his ticket medium has been checked negatively or because no ticket medium has been detected). In particular, in the closed state, there is a negative validation check of the ticket medium or no validation check at all.

The at least one blocking element can preferably be a turnstile and/or a door. A gate can also have two blocking elements in the form of two doors. In particular, a gate can comprise a respective actuator for a respective blocking element.

The actuator control equipment is configured to control the actuator in such a way that, if at least one external force acts onto the blocking element, the actuator generates an actuating force counteracting the external force up to a (dynamically adjustable according to the invention) maximum permissible actuating force. In particular, an actuator can apply an actuating force in the form of a counterforce against a force applied manually to the blocking body. If the amount of the manual force exceeds the (currently set) maximum permissible actuating force, the at least one blocking element can be (manually) moved.

According to the invention, the maximum permissible actuating force can be dynamically adjusted respectively changed during the operation of the gate arrangement, in particular, during the closed state. In particular, the maximum permissible actuating force can be adjustable (continuously or incrementally) at least between a minimum value and a maximum value.

The adjusting of the maximum permissible actuating force (during the closed state) may, for example, comprise changing the maximum permissible actuating force relative to a (predefined) maximum permissible standard actuating force. In particular, the maximum permissible actuating force can be reduced (e.g., to a minimum possible value) in order to enable easy opening of the blocking element, or the maximum permissible actuating force can be increased (e.g., to a maximum value) in order to make it as difficult as possible to open the blocking element. It shall be understood that it may also be possible to change between other actuating force values.

The at least one actuator can be a motor, in particular, an electric motor, for example in the form of a direct current motor.

The actuator respectively the blocking element drive can move a blocking element directly (i.e., without a change in transmission ratio) or with the interposition of a gearbox with a change in transmission ratio, for example, pivoting (e.g., blocking element in the form of a swing door). A coupling gearbox may be provided between the actuator and the blocking element, for example, which translates a rotational movement of the blocking element drive into a (substantially) linear movement of the blocking element. In this case, the at least one blocking element can be moved linearly and not pivoted about an axis (e.g., blocking element in the form of a sliding door).

It has been recognized that the (dynamically) adjusting of the maximum permissible actuating force should depend on the (current) situation at the gate. In order to detect this situation, the invention proposes to detect at least one force parameter causing the actuating force (in particular, at least almost continuously respectively quasi-continuously) and at least one occupancy status of the gate (in particular, at least almost continuously respectively quasi-continuously).

In this case, detecting a force parameter causing the actuating force means, in particular, detecting a parameter from which it can at least be deduced that a (manual) external force (by a user) is being exerted onto the blocking element. A force detection equipment is provided which is configured to detect at least one force parameter causing the actuating force, wherein the actuating force counteracts the external force acting on it. The force parameter can, in particular, be proportional to the actuating force. The actuating force can be (in terms of control technology) dependent on the external force. The force parameter can be (only) indirectly representative of the applied external force, such as an actuator current.

In the present case, a detecting of an occupancy status parameter of the gate means, in particular, detecting an occupancy parameter from which it can be determined whether a user is at the gate. In particular, according to the invention, an occupancy parameter of the gate is detected at a control area side of the blocking element (also referred to as “in front of the blocking element”) and at a non-control area side of the blocking element (also referred to as “behind the blocking element”). In particular, this makes it possible to determine whether (at the moment) (e.g., while the gate is closed) at least one user is at the control area side or not and whether a user is at the non-control area side or not. From this, it can be determined respectively estimated, for example, in which direction a user wishes to pass through the gate (from the control area to the non-control area or from the non-control area to the control area).

For example, if determining an external force based on a detected force parameter and determining that only one user is at the gate in the non-control area, the maximum permissible actuating force can be maximized. If determining an external force based on a detected force parameter and determining that only one user is at the gate in the control area, the maximum permissible actuating force can be minimized.

According to one embodiment of the gate arrangement according to the invention, the occupancy status detection equipment can be configured to quasi-continuously detect an occupancy status of the gate at a control area side of the blocking element and/or at a non-control area side of the blocking element. In this context, quasi-continuous means, in particular, a continuously detecting, in particular measuring, insofar as this is technically possible. In particular, a periodically detecting of the occupancy status of the gate can take place. In addition, the force detection equipment may be configured to quasi-continuously detect at least the force parameter causing the actuating force. In this context, quasi-continuous means, in particular, a continuously (e.g., periodically) detecting, in particular, measuring, insofar as this is technically possible. The at least one actuator control equipment can be configured to quasi-continuously adjust the maximum permissible actuating force of the actuator. In this context, quasi-continuous means, in particular, a continuously (e.g., periodically) adjusting, insofar as this is technically possible. In particular, it is possible to react to a situation at the gate in real time (insofar as this is technically possible).

Furthermore, according to a further embodiment of the gate arrangement according to the invention, the actuator may be configured to generate the actuating force in such a way that the actuator holds the blocking element in its current position. In particular, if the blocking element is in the closed position, the actuator may be controlled by the actuator control equipment in such a way that the blocking element is held in the closed position. Alternatively or additionally, the actuator may be configured to generate the actuating force in such a way that the actuator moves the blocking element from a non-closed position to the closed position. In particular, if the blocking element is in a non-closed position, the actuator may be controlled by the actuator control equipment in such a way that the actuator moves the blocking element from a non-closed position to the closed position.

Preferably, the gate arrangement may comprise a blocking element position sensor configured to (quasi-continuously) detect the current position respectively instantaneous position of the movable blocking element. In particular, the actuator control equipment can control the actuator based on the current position of the movable blocking element. In particular, the actuator control equipment can control the actuator in such a way that the actuator moves the blocking element from an open position to the closed position if an open position is detected by the blocking element position sensor. The actuator control equipment can also control the actuator in such a way that the actuator holds the blocking element in the closed position if a closed position is detected by the blocking element position sensor.

According to a further embodiment of the gate arrangement according to the invention, the actuator can be configured to generate the actuating force in such a way that the actuator moves the blocking element from a non-closed position to the closed position with an actuating speed that does not exceed a maximum permissible actuating speed. The at least one actuator control equipment may be configured to (dynamically) adjust the maximum permissible actuating speed based on the at least one detected force parameter and the detected occupancy status. In particular, the maximum permissible actuating speed may be adjusted based on the current situation at the gate. The safety may be further improved.

As has been described, according to one embodiment of the gate arrangement according to the invention, the gate arrangement may comprise a blocking element position sensor configured to detect the current position of the movable blocking element. The at least one actuator control equipment may be configured to adjust the maximum permissible actuating force of the actuator (and/or the maximum permissible actuating speed) further based on the detected current position of the blocking element and/or a detected force direction (as will be described in more detail below).

According to one embodiment of the gate arrangement according to the invention, the occupancy status detection equipment may comprise at least one sensor, preferably a plurality of sensors. The at least one sensor may be configured to monitor (at least almost continuously) the passage area of the gate in front of the blocking element and behind the blocking element, i.e., the non-control area side and the control area side. In other words, at least one occupancy status parameter can be detected in order to detect an occupancy status. The at least one sensor may be selected from the group comprising light points, light grids, cameras, radar, weight sensors, or other sensors for presence detection. It shall be understood that an occupancy status detection equipment may comprise two or more (different) sensors.

According to a further embodiment of the gate arrangement according to the invention, the force detection equipment may comprise at least one actuator sensor. The at least one actuator sensor may be configured to detect, in particular, measure, (as a first force parameter) at least one actuator parameter (at least during the closed state). An actuator parameter, in particular a motor parameter, is, in particular, a parameter present or applied to the actuator during the closed state. In particular, it has been recognized that a change in the at least one actuator parameter can be used to infer the presence (or absence) of an external force acting onto the blocking element.

According to a preferred embodiment of the gate arrangement according to the invention, the actuator sensor can be configured to detect a motor current applied to the actuator (as an actuator parameter). In particular, it can be concluded from the applied motor current whether the actuator in the form of a motor exerts a counterforce to an external force applied to the blocking element.

According to a further embodiment of the gate arrangement according to the invention, the force detection equipment may comprise the at least one blocking element position sensor. The blocking element position sensor may be configured to detect, in particular, measure, (preferably as a further respectively second force parameter) a position parameter of the blocking element (at least during the closed state), as already described. In particular, detecting a position parameter may comprise a (quasi-continuously) monitoring of the position of the blocking element, in particular, detecting a change relative to the rest position of the blocking element. In particular, it has been recognized that a change in the at least one position parameter respectively position parameter value (relative to a rest position parameter respectively rest position parameter value) can be used to infer an external force acting on the blocking element.

It is particularly preferred that the first force parameter and the second force parameter can be (quasi-continuously) detected and, in particular, evaluated during the closed state.

According to a preferred embodiment of the gate arrangement according to the invention, the blocking element position sensor can be configured to detect a blocking element angle in relation to a rest position of the blocking element (at least during the closed state). The at least one blocking element position sensor may comprise respectively be at least one position meter respectively position sensor, for example, in the form of an incremental encoder for measuring angular changes (relative to a predefined rest position of the blocking element in which no external force is exerted onto the blocking element). The blocking element position sensor may, for example, be attached to the blocking element or to the actuator.

Particularly preferable, the motor current of the actuator of the blocking element, the angular change in the position of the blocking element (relative to the predefined rest position), and the occupancy status in front of and behind the blocking element can be detected, determined, and, in particular, evaluated for a blocking element.

Furthermore, according to a further embodiment of the gate arrangement according to the invention, the force detection equipment can be configured to detect a force direction of an external force exerted onto the blocking element. In particular, the direction of force can be detected and, in particular, determined by means of the blocking element position sensor, for example, determined from the measured angular change. By detecting and, in particular, determining the direction of force of an external force exerted onto the blocking element, the situation at the gate during the closed state can be estimated even more accurately.

According to a further embodiment of the gate arrangement according to the invention, the gate arrangement may comprise at least one brake. The brake may be configured to (mechanically) block a moving of the blocking element, in particular, during the closed state of the blocking element. The actuator control equipment can be configured to control the brake based on the at least one detected force parameter and the at least one detected occupancy status. In particular, if the detected parameters (parameter values) indicate a fraud situation, the optional brake can also be activated to prevent the blocking element from moving, in particular, in the closed position. Preferably, a brake can be implemented if the maximum adjustable maximum permissible actuating force makes it difficult to move the blocking element, but, in particular, cannot completely prevent it. Attempts of fraud can be made even more difficult in an even safer manner.

As has already been described, according to one embodiment of the gate arrangement according to the invention, the gate may comprise a further blocking element movable by a further actuator. For example, a gate may comprise exactly two blocking elements in the form of (opposite) doors, wherein a first blocking element is arranged at the first gate body and the further blocking element is arranged at the second gate body. The actuator control equipment may be configured to control the further actuator (independently of the other actuator) in such a way that, if at least one further external force acts onto the further blocking element, the further actuator generates a further actuating force counteracting the further external force up to a further maximum permissible actuating force, as has already been described analogously. The at least one force detection equipment may be configured to detect at least one further force parameter causing the further actuating force, as has already been described analogously. The at least one actuator control equipment may be configured to independently adjust the further maximum permissible actuating force (and/or the maximum permissible actuating speed) of the further actuator based on the at least one detected further force parameter and the detected occupancy status (and, in particular, a detected further instantaneous position of the further blocking element and/or a detected further force direction exerted onto the further blocking element). In particular, at least the respective maximum permissible actuating force of the two blocking elements of the gate can be adjusted independently of each other based on the situation at the gate, i.e., in particular, depending on at least some of the detected parameters mentioned above. The same may apply to the respective maximum permissible actuating speed of the two blocking elements of the gate. Safety can be further improved.

According to a particularly preferred embodiment of the gate arrangement according to the invention, the gate arrangement, in particular, the actuator control equipment, may comprise at least one evaluation equipment. The evaluation equipment can be configured to determine a gate set behavior based on a detected parameter set that includes at least the at least one detected force parameter and the at least one detected occupancy status, wherein the gate set behavior can be determined from a plurality of predefined behavior patterns that can be stored in a data memory and assigned to different predefined parameter patterns. The actuator control equipment may be configured to determine the maximum permissible actuating force based on the determined gate set behavior.

A predefined parameter set respectively a predefined parameter set range represents, in particular, a situation or scenario (with a certain probability) present at the gate. For example, a parameter set (respectively the parameter value ranges) for a defined situation (e.g., fraud situation, emergency situation, etc.) can be determined by tests and/or simulations. Each defined situation respectively each defined parameter set can be assigned a gate set behavior containing at least one value to be set for the maximum permissible actuating force. Corresponding assignments can be stored in a data memory of the gate arrangement.

The gate set behavior specifies, in particular, how the gate, in particular, the at least one blocking element, should behave in the assigned situation. In particular, a gate set behavior can be represented by a data set with at least one value to be set for the maximum permissible actuating force. A predefined parameter set respectively predefined parameter range contains, in particular, parameters respectively parameter ranges of the detectable parameters (at least one force parameter and one occupancy status).

The evaluation equipment can be configured to compare the parameters (values) of the detected parameter pattern with the respective predefined and stored parameter sets respectively parameter set ranges. If the evaluation equipment (e.g., a software module executable by a processor) determines that the parameters (values) of the detected parameter pattern lie within the predefined parameter range values of a predefined parameter set range, the evaluation equipment can determine the gate set behavior assigned to this predefined parameter set range. The actuator control equipment can then adjust at least the maximum permissible actuating force (and/or the maximum permissible actuating speed) in accordance with the determined gate set behavior, for example, by controlling the actuator (and optionally the brake) accordingly. In a simple manner, the gate can be operated in accordance with the situation based on the detected parameters.

Preferably, according to a further embodiment of the gate arrangement, the plurality of predefined behavior patterns may comprise at least one gate blocking behavior and one gate release behavior. The gate blocking behavior means, in particular, that a manually opening of the blocking element is made more difficult (compared to a standard case), in particular, to the extent that is technically feasible. For example, the gate blocking behavior can specify that the maximum permissible actuating force is set to the maximum possible value of the actuator, i.e., maximized, and optionally the brake described above is activated. In particular, the gate blocking behavior can include a value of the maximum permissible actuating force that is maximized and, optionally, an instruction datum for activating the brake. The actuator control equipment can then control the aforementioned elements accordingly.

In this case, the gate release behavior means, in particular, that a manual opening of the blocking element is facilitated (compared to a standard case), in particular, to the extent that is technically feasible. For example, the gate release behavior can specify that the maximum permissible actuating force is set to the minimum possible value of the actuator, i.e., minimized. The actuator control equipment can then control the actuator accordingly.

A gate blocking behavior can, for example, be assigned to a fraud situation respectively a predefined parameter set range representing a fraud situation, and a gate release behavior can, for example, be assigned to an emergency situation respectively a predefined parameter set range representing an emergency situation.

According to a particularly preferred embodiment of the gate arrangement according to the invention, the predefined gate blocking behavior can be assigned a predefined parameter set range containing no validation datum or an invalid validation datum, an occupied state at the non-control area side of the blocking element (i.e., in particular, a user is in front of the blocking element) and an unoccupied state at the control area side of the blocking element (i.e., in particular, no user is behind the blocking element) and at least one detected force parameter from which it can be deduced at least that an external force (and/or a moment) greater than zero is acting on the blocking element (during the closed state). This (first) predefined parameter set range can be assigned to a fraud situation in which an unauthorized user attempts to enter the control area by pushing or pulling the blocking element.

Preferably, a predefined parameter set range can additionally be assigned to the predefined gate release behavior, containing no validation datum or an invalid validation datum, an unoccupied state at the non-control area side of the blocking element (i.e., in particular, no user is in front of the blocking element) and an occupied state at the control area side of the blocking element (i.e., in particular, a user is behind the blocking element) and at least one detected force parameter from which it can at least be deduced that an external force (and/or a moment) greater than zero is acting on the blocking element (while in the closed state). This (second) predefined parameter set range can be assigned to an emergency situation in which a user wants to leave the control area by pushing or pulling the blocking element.

According to a further embodiment of the gate arrangement according to the invention, the actuator control equipment can be configured to adjust the maximum permissible actuating force (and/or maximum permissible actuating speed) by specifying a maximum permissible motor current value, in particular, based on the determined gate set behavior. In particular, the at least one predefined actuator set parameter can be the maximum permissible motor current value. In a simple manner, a maximum permissible actuating force of the actuator can be set dynamically.

Preferably, the detected parameter pattern may contain a validation datum indicating a valid validation (valid validation datum) or an invalid validation (invalid or missing validation datum) of an access authorization at the gate.

In particular, the parameter pattern can be newly detected each time the gate returns to a default state.

As has already been described, the situation that may currently exist at the gate can be assessed from at least two detected parameters (while the gate is closed). However, it has been shown that the initial assessment may be incorrect, for example, due to fraud by one or more users. For example, a situation initially assessed as an emergency may in fact be a case of fraud. In order to at least minimize the damage in such a case, a further preferred embodiment of the gate arrangement according to the invention proposes that the gate arrangement may comprise at least one analysis equipment. The analysis equipment and the evaluation equipment may form a common device.

The analysis equipment can be configured to detect a blocking element that has been moved at least partially into the open position (while in the closed state). For example, such a moving can be caused by a small external manual force due to a set reduced maximum permissible actuating force in accordance with a gate release behavior. The occupancy status detection equipment may be configured to detect the occupancy status of the gate arrangement at the control area side of the blocking element and/or at the non-control area side of the blocking element during the closed state and the at least partially open position. In particular, the respective occupancy status can be monitored at least almost continuously respectively quasi-continuously in the manner described above.

The actuator control equipment may be configured to control the actuator in such a way that the blocking element is moved into the closed position by the actuator (if necessary, at a lower speed than the normal closing speed (for example, the maximum permissible actuating speed may be reduced, as has been described)) based on the at least one detected occupancy status. In particular, if by (quasi-continuously) evaluating of the at least one (quasi-continuously) detected occupancy status it is determined that, contrary to an original assumption that a first user (in an emergency situation) wishes to leave the control area, this first user wishes to allow a further user to enter the control area from the non-control area, the blocking element can be moved into the closed position by the actuator, in particular, by controlling the actuator with a correspondingly (increased) actuator motor current. It shall be understood that this can be done in such a way that there is no risk of injury.

Alternatively or additionally (in particular, in the above example), the actuator control equipment can be configured to control an alarm equipment of the gate arrangement in such a way that the alarm equipment emits an alarm (e.g., optical and/or acoustic) based on the at least one detected occupancy status. Fraud protection can be further improved.

According to a further embodiment of the gate arrangement according to the invention, the gate arrangement may comprise a plurality of gates, as has already been described. Furthermore, the gate arrangement may comprise at least one gate controller. The gate controller may be configured to jointly control the respective pieces of actuator control equipment of the respective gates if the gate controller determines that at least two gates have a gate release behavior (determined by the evaluation equipment) at least almost simultaneously such that a respective reduced maximum permissible actuating force of the respective actuators of the gates is set. In particular, an emergency situation can be detected at a plurality of gates at least almost simultaneously. From this, it can be deduced that a large number of users wants/needs to leave the non-control area (quickly). If such a situation is detected, the gate controller can, in particular, cause all gates to be operated in accordance with the gate release behavior, in particular, by reducing the respective maximum permissible actuating force for all actuators of the gate arrangement, for example, to the minimum possible actuating force value. In variants of the invention, an actively moving of the blocking elements into the open position can also be effected by the respective actuator.

Exemplary use cases are described below:

The use cases describe examples of conceivable application scenarios/implementation options for the embodiments of the invention described above.

### 1. Fraud Situation “Pulling”

The following parameters are detected respectively derived from the mentioned parameters: An external force is applied to at least one blocking element in the direction of the non-control area and the occupancy status at the non-control area side is “occupied” (and at the control area side unoccupied respectively not occupied).

Recognized scenario respectively situation based on a (corresponding) predefined and stored parameter pattern: A user pulls at least one blocking element from the outside in order to enter the control area (without a valid ticket medium respectively valid validation datum).

The gate behavior assigned to this predefined parameter pattern is, in particular, a gate blocking behavior: e.g., pulling at the blocking element must be prevented up to the maximum force technically feasible respectively the maximum permissible actuating force must be increased accordingly and, if necessary, the brake must be activated. Furthermore, the alarm equipment can be activated optionally.

If the blocking element has nevertheless been moved, measures can be taken by the analysis equipment (as has been, in particular, described):
As soon as the blocking element is no longer moving: Close the gate at a reduced closing speed (i.e., at the set reduced maximum permissible actuating speed).
As soon as the occupancy detection device indicates that no one is near the blocking element: Close the gate at an increased closing speed (i.e., at the set increased maximum permissible actuating speed).

### 2. Fraud Situation in Which an Emergency Situation is Initially Assumed

The following parameters are detected respectively derived from the mentioned parameters: An external force is applied to at least one blocking element in the direction of the non-control area, and the occupancy status at the control area side is “occupied” (and (initially) unoccupied at the non-controlled area side).

Recognized scenario respectively situation based on a (corresponding) predefined and stored parameter pattern: At least one person must obviously enter the non-control area from the control area (emergency situation).

The gate set behavior assigned to this predefined parameter pattern is, in particular, a gate release behavior: Pressing the at least one blocking element is permitted by reducing the counterforce exerted by the motor. In other words, the maximum permissible actuating force is reduced, in particular, to a minimum possible value.

The occupancy status detection equipment then detects, while the blocking element is at least partially moved into the open position (e.g., determined by the analysis equipment) during the closed state, that the occupancy status at the non-control area side has changed and is now occupied (e.g., a further person begins to walk through the gate from the outside).

Recognized scenario respectively situation based on a (corresponding) predefined and stored parameter pattern: A person has moved the gate from the inside to allow a further person to enter (fraud situation).

Example response measures:
Closing the gate as described above and/or
Triggering an alarm as described above.

### 3. Fraud Situation: “Opposite Opening of the Blocking Elements”

The following parameters are detected or derived from the mentioned parameters:

An external force is applied to a first blocking element of the gate in the direction of the non-control area, a further external force is applied to the second blocking element of the gate in the opposite direction, and the occupancy status at the non-control area side is “occupied” (and (initially) unoccupied at the control area side).

Recognized scenario respectively situation based on a (corresponding) predefined and stored parameter pattern: At least one person obviously wants to enter the control area from the non-control area by pulling at one blocking element and pushing the other blocking element to open a passage.

The gate behavior assigned to this predefined parameter pattern is, in particular, a gate blocking behavior: e.g., pulling the respective blocking element must be prevented up to the maximum force that is technically feasible, or the respective maximum permissible actuating force must be increased accordingly and, if necessary, the brake must be activated. Furthermore, the alarm equipment can be activated optionally.

If the blocking elements have nevertheless been moved, measures can be taken by the analysis equipment (as has been described):
As soon as the blocking elements are no longer moving: Close the gate at a reduced closing speed (i.e., at the set reduced maximum permissible actuating speed).
As soon as the occupancy status detection equipment indicates that no one is near the blocking elements: Close the gate at increased closing speed (i.e., at the set increased maximum permissible actuating speed).

### 4. Fraud Situation “Unsuccessful Pressing,” in Which an Emergency Situation is Initially Assumed

The following parameters are detected or derived from the mentioned parameters: An external force is applied to at least one blocking element in the direction of the non-control area and the occupancy status at the control area side is “occupied” (and (initially) unoccupied at the non-controlled area side).

Recognized scenario respectively situation based on a (corresponding) predefined and stored parameter pattern: At least one person must obviously enter the non-control area from the control area (emergency situation).

The gate behavior assigned to this predefined parameter pattern is, in particular, a gate release behavior: Pressing the at least one blocking element is permitted by reducing the counterforce exerted by the motor or by reducing the maximum permissible actuating force.

A blocking element position sensor of the at least one blocking element can detect that the at least one blocking element has only been opened a few degrees and is not being moved any further.

Recognized scenario or situation based on a (corresponding) predefined and stored parameter pattern: Break through attempt.

The analysis equipment can, for example, trigger the following measures (as has been described):
As soon as the blocking element is no longer being moved: Closing of the gate at a reduced closing speed (i.e., at a set reduced maximum permissible actuating speed)
As soon as the occupancy status detection equipment indicates that no one is near the blocking elements: Close the gate at an increased closing speed (i.e., at the set increased maximum permissible actuating speed).
Trigger an alarm.

### 5. Fraud Case: “Hold Neighboring Gate Open”

A first gate has at least one blocking element that is in the open position.

The occupancy status detection equipment of the first gate detects, in particular, that the passage “in front of” and “behind” the at least one blocking element of the first gate is regularly passed through by a person.

The at least one blocking element is to be closed normally (the gate is already in the closed state during the closing process).

The following parameters are detected respectively derived from the mentioned parameters:
An external force is applied to at least one blocking element and the occupancy status at the control area side is unoccupied and at the non-control area side is unoccupied.

Recognized scenario respectively situation based on a (corresponding) predefined and stored parameter pattern: A further person is standing in the neighboring gate and attempting to hold open at least one open blocking element. (If necessary, the occupancy status detection equipment of the neighboring gate can also be evaluated for this purpose). The at least one blocking element of the first gate may also have become jammed or similar.

The gate set behavior assigned to this predefined parameter pattern is, in particular, a gate blocking behavior: Closing of the at least one held open blocking element up to the technically feasible maximum force respectively the maximum permissible actuating force is set to the maximum possible value (in particular, a reduced maximum permissible actuating speed can be set) and, in particular, an alarm is triggered, as has already been described.

### 6. Emergency Situation: A Single Person at a Single Gate

The following parameters are detected respectively derived from the mentioned parameters:
An external force is applied to at least one blocking element in the direction of the non-control area and the occupancy status at the controlled area side is “occupied” (and (initially) unoccupied at the non-control area side).

Recognized scenario respectively situation based on a (corresponding) predefined and stored parameter pattern: At least one person must obviously enter the non-control area from the control area (emergency situation).

The gate set behavior assigned to this predefined parameter pattern is, in particular, a gate release behavior: Pressing the at least one blocking element is permitted by reducing the counterforce exerted by the motor, i.e., the maximum permissible actuating force is dynamically reduced, in particular, to the minimum possible value, as has already been described above.

The occupancy status detection equipment detects, in particular, that a person has left the gate on the outside.

Recognized scenario respectively situation based on a (corresponding) predefined and stored parameter pattern: At least one person has used the gate as an emergency exit.

Example response measure: As soon as the occupancy status detection equipment indicates that no one is near the blocking elements: Close the gate at an increased closing speed, i.e., the maximum permissible actuating speed can be increased accordingly.

### 7. Emergency Situation: Several Persons at a Single Gate

The following parameters are detected respectively derived from the mentioned parameters:
An external force is applied to at least one blocking element in the direction of the non-control area and the occupancy status at the control area side is “occupied” (and (initially) unoccupied at the non-control area side).

Recognized scenario respectively situation based on a (corresponding) predefined and stored parameter pattern: At least one person must obviously enter the non-control area from the control area (emergency situation).

The gate set behavior assigned to this predefined parameter pattern is, in particular, a gate release behavior: The pressing of the at least one blocking element is permitted by reducing the counterforce exerted by the motor, i.e., the maximum permissible actuating force is dynamically reduced, in particular, to the minimum possible value, as has already been described above.

The occupancy status detection equipment detects, in particular, that a person has left the gate on the outside.

The occupancy status detection equipment then detects that more people are passing through the gate to leave the control area.

Recognized scenario respectively situation based on a (corresponding) predefined and stored parameter pattern: Several persons have used the gate as an emergency exit.

Example response measure: As soon as the occupancy status detection equipment indicates that no one is near the blocking elements: Close the gate at a reduced closing speed, as has been described above.

### 8. Emergency Situation: A Large Number of People at Several Gates of a Gate Arrangement

A gate controller (also referred to as a gate array controller or station controller) detects that the 6th or 7th situation is present at a large number of gates in a gate arrangement.

Detected scenario: There appears to be a major emergency. The gate controller preferably causes all gates of the gate arrangement to open.

Example response measure, in particular, only by the gate controller: Return to normal operation.

A further aspect of the invention is a method for operating a gate array, in particular, a gate array according to one of the preceding claims, wherein the gate array comprises at least one gate having a first gate body and a second gate body arranged adjacent to the first gate body, wherein the first gate body and the second gate body define a passageway between a control area and a non-control area, and at least one blocking element movable between an open position and a closed position by at least one actuator of the gate, and at least one actuator control equipment configured to control the actuator in such a way that the actuator moves the blocking element into a predefined position, wherein the actuator control equipment is configured to control the actuator in such a way that, if at least one external force acts onto the blocking element, the actuator generates an actuating force counteracting the external force up to a maximum permissible actuating force. The method comprises:
detecting, by at least one occupancy status detection equipment, an occupancy status of the gate at a control area side of the blocking element and/or at a non-control area side of the blocking element,
detecting, by at least one force detection equipment, at least one force parameter of the acting external force causing the actuating force, and
adjusting, by the at least one actuator control equipment, the maximum permissible actuating force of the actuator based on the at least one detected force parameter and the detected occupancy status.

A further aspect of the invention is a computer program comprising instructions that cause a processor of a gate arrangement, in particular, a gate arrangement described above (according to claim 1) to execute and/or control the method steps of the method described above.

The computer program can be installed in a computing device (e.g., processor) of a gate arrangement. It serves, in particular, to control at least one (previously described) force detection equipment, at least one occupancy status detection equipment, and at least one actuator control equipment. The computer program is a software application executable by one or more processors of the gate arrangement.

The computer program, in particular, the instructions or program commands, can be stored in a computer program product, in particular, a program memory. For example, a program memory is a non-volatile memory such as a flash memory, a magnetic memory, an EEPROM memory (electrically erasable programmable read-only memory), and/or an optical memory.

In addition, a computing device of the gate arrangement may comprise a main memory, for example a volatile or non-volatile memory, in particular a random access memory (RAM), such as a static RAM (SRAM), a dynamic RAM (DRAM), a ferroelectric RAM (FeRAM), and/or a magnetic RAM (MRAM). The processor of the gate arrangement can, for example, store intermediate results or similar in the main memory.

A further aspect of the invention is a passenger transport system comprising at least one transport vehicle and at least one gate arrangement described above, wherein the gate arrangement is configured to control access to the transport vehicle, in particular, from a non-control area via the control area to the transport vehicle.

Preferably, the passenger transport system may comprise a background system. A background system may comprise one or more (distributed) computing devices and may serve, in particular, as a server arrangement. Processor-executable (software) modules/pieces of equipment may be installed on the background system. The background system may be communicatively connected to the at least one gate arrangement by means of a (wireless and/or wired) communication network, in particular, for the purpose of exchanging data.

In variants of the invention, an equipment/device respectively a module of the gate arrangement may also be implemented at least partially in the background system. For example, a validation module may be implemented at least partially in the background system.

Furthermore, the passenger transport system may comprise at least one predefined ticket medium.

A previously described module, device, equipment, etc. may comprise at least partially hardware elements (e.g., processor, storage means, etc.) and/or at least partially software elements (e.g., executable code). It should also be noted that terms such as “first,” “second,” “further,” etc. do not indicate an order, but serve, in particular, to distinguish between two elements (e.g., blocking element, gate body, gate, etc.).

The features of the gate arrangements, methods, computer programs, and passenger transport systems can be freely combined with each other. In particular, features of the description and/or the dependent claims, even when completely or partially circumventing features of the independent claims, can be independently inventive when used alone or freely combined with each other.

### BRIEF DESCRIPTION OF THE DRAWINGS

There is now a multitude of possibilities for designing and further developing the gate arrangement, the passenger transport system, the method, and the computer program according to the invention. Reference should be made here to the patent claims subordinate to the independent patent claims on the one hand, and to the description of embodiments in conjunction with the drawing on the other. The drawing shows:

FIG. 1a shows a schematic top view of an embodiment of a gate arrangement according to the present invention,

FIG. 1b shows a schematic front view of the embodiment according to FIG. 1a,

FIG. 2 shows a schematic view of a conceptual diagram of the present invention,

FIG. 3 shows a schematic view of an embodiment of a passenger transport system according to the present invention, and

FIG. 4 shows a diagram of an embodiment of a method according to the present invention.

### DETAILED DESCRIPTION

Similar elements are designated with similar reference numerals below. An example of a passenger transport system in which a gate arrangement according to the invention can be used is shown below. It shall be understood that the following descriptions can also be applied to other application systems respectively application areas in which a gate arrangement according to the invention can be used, in which the authorization of users to enter or leave a control area is to be checked, such as at sporting events, cultural events, or leisure events.

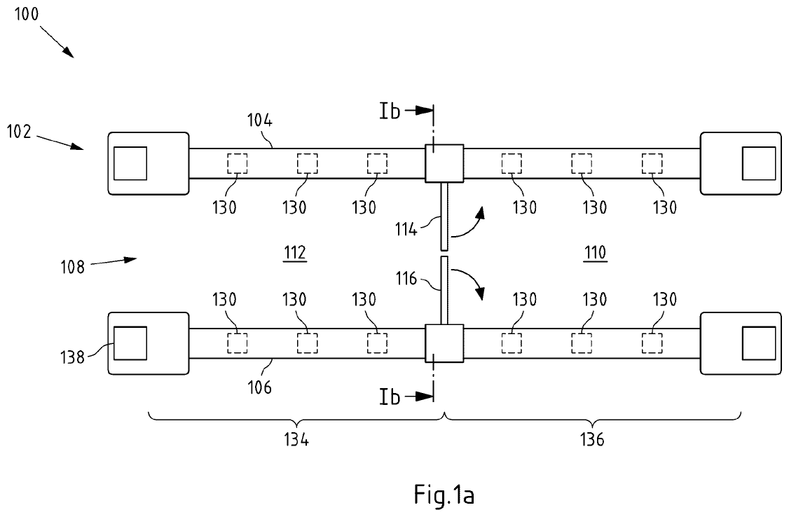

FIG. 1a shows a schematic top view of an embodiment of a gate arrangement 100 according to the present invention, and FIG. 1b shows a front view of the embodiment according to FIG. 1a at the intersection line Ib-Ib.

The gate arrangement 100 is, in particular, intended for use in a (not shown) passenger transport system. The (public) passenger transport system comprises at least one gate arrangement 100, in particular, a plurality of gate arrangements 100. In addition, the passenger transport system may comprise at least one transport vehicle, preferably a plurality of transport vehicles, each configured to transport a plurality of users. The transport vehicle is located in a control area 110 of the passenger transport system respectively can only be entered and exited by means of respective control areas. A use of the transport vehicle respectively an entering into the control area 110 by a user requires a valid access authorization respectively a valid (not shown) ticket medium.

The at least one gate arrangement 100 is configured to separate an uncontrolled area respectively non-control area 112 from the controlled area respectively control area 110. This means, in particular, that entering and/or leaving the control area 110 is controlled by the at least one gate arrangement 100.

The shown gate arrangement 100 comprises a gate 102 respectively a passage barrier. In variants of the invention, the gate arrangement may comprise at least one further gate, which may be, in particular, arranged adjacent to the gate.

The gate 102 has a first gate body 104, which is, in particular, elongated, and a second gate body 106, which is, in particular, elongated and arranged adjacent (in particular, parallel) to the first gate body 104. The first gate body 104 and the second gate body 106 define a passageway 108 from the non-control area 112 to the control area 110.

Furthermore, the gate 102 comprises at least one blocking element 114, 116. In this case, two blocking elements 114, 116 are provided, each in the form of a pivotable door (indicated by the arrows). A first blocking element 114 is arranged at the first gate body 104 and a further blocking element 116 is arranged opposite it at the second gate body 106. The at least one blocking element 114, 116 can be moved between an open position and a closed position by at least one actuator 118, 120. In particular, a respective actuator 118, 120 may be provided for each blocking element 114, 116, in particular, in the form of an electric motor, such as a direct current motor. Preferably, the two blocking elements 114, 116 can be moved synchronously by the respective actuators 118, 120 in normal operation, i.e., they can be moved at least almost simultaneously into the open position (in the case of a positive validation result), moved back into the closed position, and held in the closed position (which is shown in FIG. 1).

In the closed position, in which, for example, the at least one blocking element 114, 116 is located in FIGS. 1a and 1b, the passageway 108 through the gate 102 is blocked. In the (not shown) open position, a user can pass through the gate 102 via the passageway 108.

The gate 102 (in this case, the second gate body 106 of the gate 102) comprises at least one reading module 138. The reading module 138 is, in particular, configured to detect a ticket medium held by a user within the (reading) range of the reading module 138. Preferably, the reading module 138 can be an NFC reading module or an optical reading module (e.g., barcode scanner or QR code scanner). It shall be understood that in variants of the invention, two or more (different) reading modules may be provided.

As has already been described, the at least one actuator 118, 120 is configured to move the at least one blocking element 114, 116 at least based on a validation check of the detected ticket medium. For example, the gate arrangement 100 may comprise a (not shown) validation module. In other variants, a (not shown) background system of the passenger transport system may comprise the validation module.

The validation module may be configured to perform a (conventional) validation check. In particular, by evaluating a ticket code read from the ticket medium containing an access authorization, it can be determined whether or not the ticket medium is a valid ticket medium, i.e., whether or not a valid validation datum is present.

If the validation check result is positive respectively the validation date is valid, i.e., if it is determined that the ticket medium is a valid ticket medium respectively includes a valid access authorization, the gate 102 respectively the blocking element 114, 116 can be set to the open state respectively the validated state. In the open state, the gate 102 can be released by moving at least one blocking element 114, 116 by means of at least one actuator 118, 120 into the open position. After a user has passed through the passageway 108, the gate 102 respectively the blocking element 114, 116 can be set (back) to the closed state respectively the invalidated state. In the closed state, the blocking element is then moved to the closed position until a positive validation check result is obtained again.

In the event of a negative check result, if it is determined that the ticket medium is an invalid ticket medium respectively contains an invalid access authorization, i.e., no validation date or no valid validation date is determined, the gate 102 respectively the at least one blocking element 114, 116 may remain in the closed position. In the closed state and, in particular, in the closed position, a maximum permissible actuating force is specified for the at least one actuator 118, 120 of the at least one blocking element 114, 116, which can be exerted onto the blocking element. As will be described in more detail below, according to the invention, this maximum permissible actuating force is dynamically adjustable respectively variable.

The gate 102 is assigned a first passage section in front of the blocking element 114, 116, also referred to as the non-control area side 134, which must be passed, in particular, by a user in front of the blocking element 114, 116, who wants to respectively will pass through the gate 102 respectively the passageway from the non-control area 112 to the control area 110. Furthermore, a second passage section behind the blocking element 114, 116, also referred to as the control area side 136, is assigned to the gate 102, which, in particular, must be passed by a user after the blocking element 114, 116, who wants to respectively will pass through the gate 102 respectively the passageway from the non-control area 112 to the control area 110.

According to the invention, the gate arrangement 100 comprises at least one force detection equipment, in the present case comprising at least one actuator sensor 122, 124 and at least one blocking element position sensor 132, 140. The force detection equipment is configured to detect at least one force parameter causing the actuating force at least during the closed state.

In particular, the respective actuator sensor 122, 124 can be configured to detect a respective first force parameter in the form of an actuator parameter of the respective actuator 118, 120. The at least one actuator parameter is preferably the motor current of the actuator 118, 120 applied to the actuator 118, 120.

Preferably, the blocking element position sensor 132, 140 can be configured to detect a further force parameter in the form of a position parameter of the blocking element 114, 116 at least during the closed state, in particular, in relation to a rest position of the blocking element 114, 116. The rest position of a blocking element 114, 116 in this case refers, in particular, to the position of the blocking element 114, 116 that it takes up in the closed position if no external force is acting on it.

Preferably, the position parameter can be a blocking element angle in relation to the rest position of the blocking element 114, 116. The blocking element position sensor 132, 140 can, for example, be an incremental encoder for measuring angular changes. In particular, the at least one blocking element position sensor 132, 140 may (also) be configured to detect a force direction of an external force exerted onto the respective blocking element 114, 116. For example, the force direction can be derived from the blocking element angle (e.g., the sign of the measured blocking element angle). In particular, in the present embodiment, the blocking elements 114, 116 can be monitored independently from each other. Preferably, based on the respective detected parameter values, an independently executable adjustment of the respective maximum permissible actuating force can also be performed.

Furthermore, the gate arrangement 100 comprises at least one occupancy status detection equipment, for example, comprising a plurality of sensors 130. The occupancy status detection equipment is configured to detect an occupancy status of the gate 102 at a control area side 136 of the blocking element 114, 116 respectively gate 102 and preferably additionally at a non-control area side 134 of the blocking element 114, 116 respectively gate 102, at least during the closed state. In particular, the respective occupancy status of the respective passage sub-areas can be continuously monitored and evaluated. The at least one sensor 130 may be selected from the group comprising light points, light grids, cameras, radar, weight sensors or other sensors for presence detection. It shall be understood that an occupancy status detection equipment may comprise two or more different types of sensors.

In addition, the gate arrangement 100 comprises at least one actuator control equipment 126, 128. In the present case, two pieces of actuator control equipment 126, 128 are provided as examples. The respective pieces of actuator control equipment 126, 128 are configured to control the respective actuators 118, 120 in such a way that the respective actuators 118, 120 move the respective blocking elements 114, 116 into a predetermined position, as has, in particular, been described above. Furthermore, the respective piece of actuator control equipment 126, 128 is configured to control the respective actuator 118, 120 in such a way that, if at least one external force acts onto the respective blocking element 114, 116, the respective actuator 118, 120 generates a respective actuating force counteracting the external force up to the respective maximum permissible actuating force.

According to the invention, the respective actuator control equipment 126, 128 is configured to adjust respectively set the respective maximum permissible actuating force of the respective actuator 118, 120, in particular, at least during the closed state, based on the at least one detected force parameter (preferably at least the actuator parameter and the position parameter and, in particular, the force direction) and the at least one detected occupancy status (preferably the occupancy status (occupied or unoccupied) of the non-control area side 134 of the blocking element 114, 116 and the occupancy status (occupied or unoccupied) of the control area side 136 of the blocking element 114, 116). In particular, it can be deduced from the detected parameters mentioned above whether or not a fraud situation or an emergency situation (or another situation) is present at the gate 102.

As has been described, the value of the maximum permissible actuating force of the at least one actuator 118, 120 can be increased (for example, to a maximum possible actuating force value) if the actuator control equipment 126, 128 (and/or an evaluation equipment) deduces from the aforementioned detected parameters that a fraud situation is present. Optionally, in this case, a (not shown) brake of the respective blocking element 114, 116 can be activated to block it (e.g., mechanically).

Furthermore, the value of the maximum permissible actuating force of the at least one actuator 118, 120 can be reduced (for example, to a minimum possible actuating force value) if the actuator control equipment 126, 128 (and/or an evaluation equipment) deduces from the aforementioned detected parameters that an emergency situation is present.

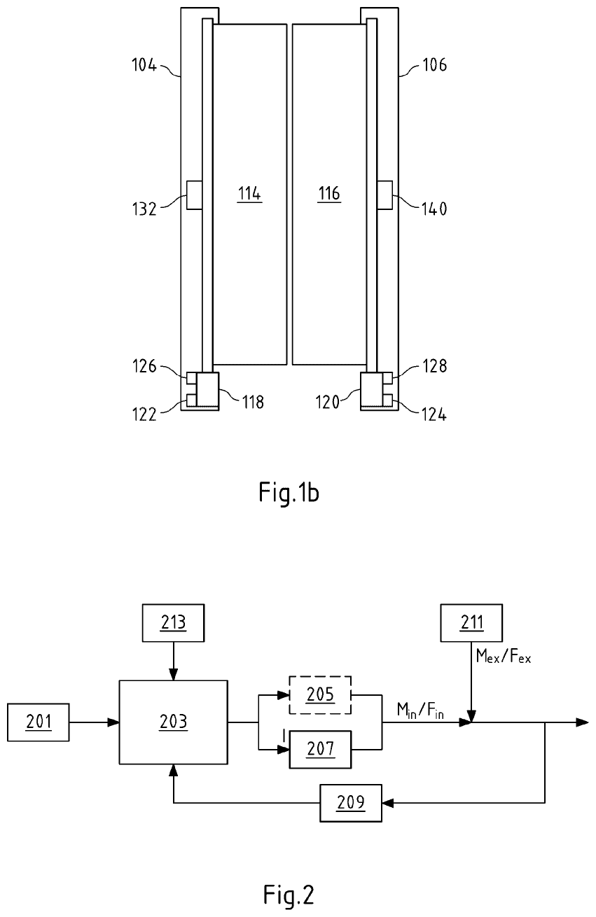

FIG. 2 shows a conceptual diagram of the invention in order to explain in more detail the functioning of the gate arrangement (e.g., according to FIG. 1) according to a preferred embodiment.

The actuator control equipment 203, in particular, in combination with the evaluation equipment, which may be integrated in the actuator control equipment 203, receives a validation datum (valid or invalid) from the validation interface 201 respectively the validation module.

Furthermore, the aforementioned actuator control equipment 203 receives the (current) occupancy status of the non-control area side of the blocking element and the control area side of the blocking element from the occupancy status detection equipment 213. In particular, the respective occupancy status can be detected and provided quasi-continuously. In addition, the actuator control equipment 203 is aware of the applied motor current I of the actuator 207 respectively drive and the actual position of the blocking element provided by a position parameter sensor 209.

Based on the aforementioned input parameters, the actuator 207 respectively drive and an optional brake 205 are controlled by the actuator control equipment 203, in particular, depending on a predefined gate set behavior. From the controlling an internal force Fᵢₙ and/or an internal torque Mᵢₙ results (which is based on a force). The block 211 represents a user who pushes or pulls at the blocking element, i.e., exerts an external force Fₑₓ and/or an external torque Mₑₓ (which is based on a force) at the at least one blocking element, which can result in a blocking element movement (and a change in the motor current). The blocking element movement can be detected by the position parameter sensor 209 respectively form the input of the position parameter sensor 209. The change in motor current can be detected (quasi-continuously) by a force detection equipment.

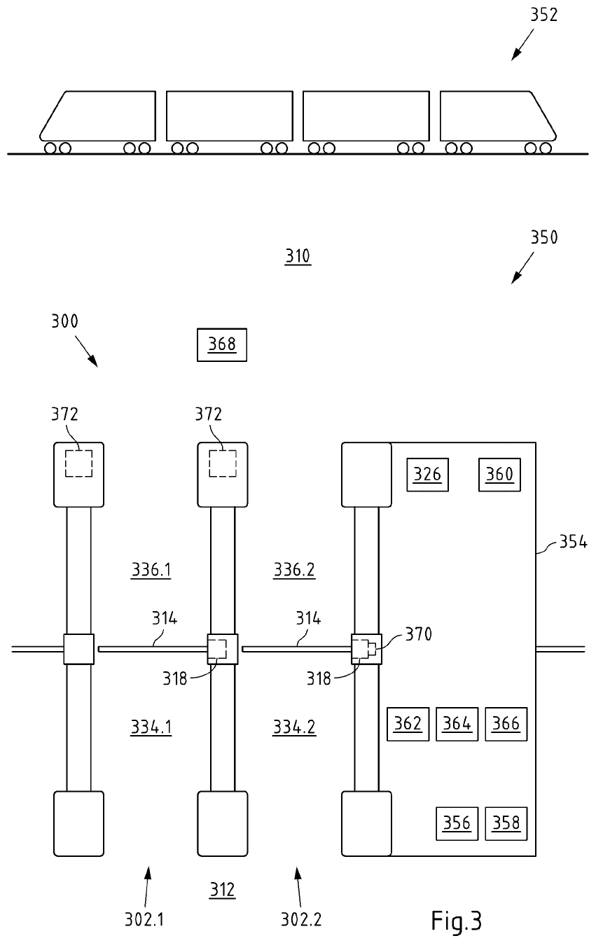

FIG. 3 shows a schematic view of an embodiment of a passenger transport system 350 with an embodiment of a gate arrangement 300 according to the present invention. In order to avoid repetitions, only the differences to the previous embodiments according to FIGS. 1 and 2 are described below, and otherwise reference is made, in particular, to the descriptions of these Figures. In particular, the representation respectively designation of details of the gate arrangement 300 (e.g., the gate body, reading modules, etc.) has been omitted solely for the sake of clarity.

The passenger transport system 350 comprises at least one transport vehicle 352, in particular, a plurality of transport vehicles 352. For example, one or more rail vehicles may be provided.

The gate arrangement 300 of the passenger transport system 350 is configured to control access to the at least one transport vehicle 352 from the non-control area 312 to the control area 310 (and, in particular, exit from the control area 310 to the non-control area 312). The gate arrangement 300 may, for example, be located at or in a station and may, for example, control access to the tracks respectively platforms.

In the present case, the gate arrangement 300 comprises, for example, two gates 302.1, 302.2 arranged adjacent to each other, which, in particular, can be formed to be essentially identical in construction. In the present case, each gate 302.1, 302.2 comprises at least one blocking element 314 and at least one actuator 318 configured to move the blocking element 314 between an open position and a closed position.

Furthermore, the gate arrangement 300 comprises a force detection equipment 370 (which may be, for example, formed as shown in FIG. 1) configured to detect at least one external force parameter acting on the blocking element 314 while the gate 302.1, 302.2 respectively blocking element 314 is in the closed state. The gate arrangement 300 further comprises at least one occupancy status detection equipment 368, such as a camera system. Alternatively or additionally, light points, light grids, radar devices, weight sensors, and/or other sensors for presence detection may also be provided. The occupancy status detection equipment 368 is configured to detect an occupancy status of the gate 302.1, 302.2 at a respective control area side 336.1, 336.2 of the respective blocking element 314 and/or at a respective non-control area side 334.1, 334.2 of the respective blocking element 314.

In the present case, the gate arrangement 300 comprises a computing device 354 (e.g., a computer) with at least one processor 356 and a storage means 358. The computing device 354 may be integrated in a gate body or may be a separate device. The computing device 354 may comprise the at least one (previously described) actuator control equipment 326 (executable by the processor 356 and the storage means 358), an optional evaluation equipment 360 (executable by the processor 356 and the storage means 358), an optional data memory 362, an optional analysis equipment 364 (executable by the processor 356 and the storage means 358), and an optional gate controller 366 (executable by the processor 356 and the storage means 358). In particular, the evaluation equipment and/or the analysis equipment may be integrated in the actuator control equipment.

Two or more predefined gate set behaviors may be stored in the data memory 362. In particular, predefined behavior patterns may be provided which are stored in the data memory 352 and assigned to different predefined parameter set ranges. A gate set behavior may, in particular, comprise at least the value to be set for the maximum permissible actuating force of an actuator if a situation respectively parameter pattern corresponding to the assigned predefined parameter set range is detected.

A gate set behavior represents, in particular, a desired behavior of the gate upon detection of a defined situation respectively a defined scenario at the gate 302.1, 302.2, which is predefined by a parameter set respectively parameter set range. In particular, it can be checked (quasi-continuously) whether a (quasi-continuously) detected parameter pattern corresponds to a predefined parameter set respectively lies within a predefined parameter set range.

The detected parameter pattern contains at least the at least one detected force parameter (preferably at least one actuator parameter and one position parameter and, in particular, a force direction) and the at least one detected occupancy status (preferably the occupancy status of the non-control area side 334.1, 334.2 of the blocking element 314 and the occupancy status of the control area side 336.1, 336.2 of the blocking element 314).

As has, in particular, been described, at least one predefined parameter pattern can be assigned to respectively comprised by each predefined gate set behavior. For example, one or more predefined parameter set ranges can be stored in an assignment table for each respective gate set behavior. At least one value to be set for the maximum permissible actuating force of an actuator can be assigned to each predefined parameter pattern range. Preferably, at least one gate blocking behavior (with one or more predefined first parameter set ranges) and one gate release behavior (with one or more predefined second parameter set ranges that differ from the at least one first parameter pattern) can be stored in the data memory 362.

The evaluation equipment 360 is, in particular, configured to determine whether a detected parameter pattern corresponds to a stored (e.g., first or second) parameter set range, i.e., whether the detected parameters (values) are identical to the predefined parameters (values) respectively lie within the parameter value ranges of the stored (e.g., first or second) parameter set ranges. If the evaluation equipment 360 determines that a detected parameter pattern corresponds to a stored respectively predefined parameter set range, i.e., identifies a predefined parameter set range, the evaluation equipment 360 determines the gate set behavior respectively at least the value to be set for the maximum permissible actuating force of an actuator that is assigned to the identified parameter set range. Then, the actuator control equipment can at least adjust the maximum permissible actuating force of the actuator in accordance with the identified value to be set for the maximum permissible actuating force.

If, for example, a first predefined parameter set range is identified by the aforementioned comparison, the evaluation equipment 360 can provide the gate blocking behavior respectively at least the value to be set for the maximum permissible actuating force of an actuator of the actuator control equipment 326. The actuator control equipment 326 can then control the corresponding actuator 318 accordingly and adjust at least the maximum permissible actuating force accordingly, as has, in particular, been described above. If, for example, a second predefined parameter set range is identified in the aforementioned comparison, the evaluation equipment 360 can provide the gate release behavior respectively the value to be set for the maximum permissible actuating force of the actuator control equipment 326. The actuator control equipment 326 can then control the corresponding actuator 318 accordingly and adjust at least the maximum permissible actuating force accordingly, as has, in particular, been described above. If the evaluation equipment 360 cannot identify a predefined parameter set range by means of the aforementioned comparison, the currently set maximum permissible actuating force can remain unchanged, in particular, a predefined maximum permissible standard actuating force.

The analysis equipment 364 (which may be integrated in the evaluation equipment 360) may be configured to detect a blocking element 314 that has been moved at least partially into the open position (by an externally applied force) during the closed state, i.e., if there is no positive validation check, for example, based on the at least one detected position parameter. The occupancy status detection equipment 368 may be configured to detect the occupancy status of the gate arrangement 300 at the control area side 336.1, 336.2 of the blocking element 314 and, in particular, at the non-control area side 334.1, 334.2 of the blocking element 314.

The actuator control equipment 326 may be configured to control the actuator 318 in such a way that the blocking element 314 is moved into the closed position by the actuator 318 based on the at least one detected occupancy status, and in particular, with an adjusted maximum permissible actuating speed. Alternatively or additionally, the actuator control equipment 326 may be configured to control an (e.g., acoustic and/or optical) alarm equipment 372 of the gate arrangement 300 in such a way that an alarm is emitted by the alarm equipment 372. The control of the alarm equipment 372 is based, in particular, on the at least one detected occupancy status during the closed state or non-validated state with the blocking element at least partially open (due to an external force being exerted), as has, in particular, already been described.

As shown in FIG. 3, the gate arrangement 300 may comprise a plurality of gates 302.1, 302.1 and at least one gate controller 366. The gate controller 366 can be configured to jointly control the respective pieces of actuator control equipment 326 (in this case, only one joint controller is shown as an example, wherein each gate 302.1, 302.1 or even each actuator 318 can have a separate actuator control equipment in further variants of the invention) of the respective gates 302.1, 302.1, if the gate controller 366 determines that a gate release behavior is determined at least almost simultaneously for at least two gates 302.1, 302.1. In particular, by the controlling it can at least be caused that a reduced maximum permissible actuating force of the actuators 318 is set. For example, the gate controller 366 can even cause all gates 302.1, 302.1 to open in this case, as has, in particular, already explained above.

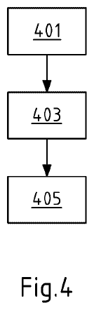

FIG. 4 shows a diagram of an embodiment of a (computer-implemented) method according to the present invention for operating a gate arrangement, in particular, a gate arrangement according to FIGS. 1 and/or 3. The gate arrangement comprises at least one gate having a first gate body and a second gate body arranged adjacent to the first gate body, wherein the first gate body and the second gate body define a passageway between a control area and a non-control area, and at least one blocking element movable between an open position and a closed position by at least one actuator of the gate, and at least one actuator control equipment configured to control the actuator in such a way that the actuator moves the blocking element into a predefined position, wherein the actuator control equipment is configured to control the actuator in such a way that, if at least one external force acts onto the blocking element, the actuator generates an actuating force counteracting the external force up to a maximum permissible actuating force.

In step 401, a detecting is performed, by at least one occupancy status detection equipment, of an occupancy status of the gate at a control area side of the blocking element and/or at a non-control area side of the blocking element, as has, in particular, been described above. This step can be performed at least almost continuously during the closed state.

In step 403, a detecting is performed, by at least one force detection equipment, of at least one force parameter of the acting external force that causes the actuating force, as has, in particular, been described above. This step can be performed at least continuously and, in particular, in parallel with step 401, at least during the closed state.

In step 405, an adjusting is performed, by the at least one actuator control equipment, of the maximum permissible actuating force of the actuator based on the at least one detected force parameter and the detected occupancy status, as has, in particular, been described above.

In particular, (re)adjusting can always be performed if the detected parameter pattern has changed. For example, if, based on the embodiment shown in FIG. 3, a parameter pattern corresponding to a second predefined parameter set range is initially detected, the maximum permissible actuating force can be adjusted according to the value of a gate release behavior. If, during continuously monitoring, a parameter pattern corresponding to a first predefined parameter set range is then detected, the maximum permissible actuating force can be adjusted according to the value of a gate blocking behavior.

### LIST OF REFERENCE SYMBOLS

100 gate arrangement
102 gate
104 gate body
106 gate body
108 passageway
110 control area
112 non-control area
114 blocking element
116 blocking element
118 actuator
120 actuator
122 actuator sensor
124 actuator sensor
126 actuator control equipment
128 actuator control equipment
130 sensor
132 blocking element position sensor
134 non-control area side
136 control area side
138 reading module
140 blocking element position sensor
201 validation interface
203 actuator control equipment
205 brake
207 actuator
209 position parameter sensor
211 block
213 occupancy status detection equipment
300 gate arrangement
302.1 gate
302.2 gate
310 control area
312 non-control area
314 blocking element
318 actuator
326 actuator control equipment
334 non-control area side
336 control area side
350 passenger transport system
352 transport vehicle
354 calculation device
356 processor
358 storage means
360 evaluation equipment
362 data memory
364 analysis equipment
366 gate controller
368 occupancy status detection equipment
370 force detection equipment
372 alarm equipment
401 step
403 step
405 step

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gate arrangement, comprising:
at least one gate having a first gate body and a second gate body arranged adjacent to the first gate body, wherein the first gate body and the second gate body define a passageway between a control area and a non-control area, and having at least one blocking element movable between an open position and a closed position by at least one actuator of the gate,
an actuator control equipment configured to control the actuator in such a way that the actuator moves the blocking element into a predefined position,
wherein the actuator control equipment is configured to control the actuator in such a way that, if at least one external force acts onto the blocking element, the actuator generates an actuating force counteracting the external force up to a maximum permissible actuating force,
wherein
the gate arrangement comprises at least one occupancy status detection equipment configured to detect an occupancy status of the gate at a control area side of the blocking element and/or on a non-control area side of the blocking element,
the gate arrangement comprises at least one force detection equipment configured to detect at least one force parameter causing the actuating force, wherein the actuating force counteracts the acting external force, and
the at least one actuator control equipment is configured to adjust the maximum permissible actuating force of the actuator based on the at least one detected force parameter and the detected occupancy status.

2. The gate arrangement according to claim 1, wherein
the occupancy status detection equipment is configured to quasi-continuously detect an occupancy status of the gate,
the force detection equipment is configured to quasi-continuously detect at least the force parameter causing the actuating force, and
the at least one actuator control equipment is configured to quasi-continuously adjust the maximum permissible actuating force of the actuator.

3. The gate arrangement according to claim 1, wherein
the actuator is configured to generate the actuating force in such a way that the actuator holds the blocking element in its current position, and/or
the actuator is configured to generate the actuating force such that the actuator moves the blocking element from a non-closed position to the closed position.

4. The gate arrangement according to claim 1, wherein
the actuator is configured to generate the actuating force in such a way that the actuator moves the blocking element from a non-closed position to the closed position with an actuating speed that does not exceed a maximum permissible actuating speed,
wherein the at least one actuator control equipment is configured to adjust the maximum permissible actuating speed based on the at least one detected force parameter and the detected occupancy status.

5. The gate arrangement according to claim 1, wherein
the force detection equipment is configured to detect a force direction of an external force exerted onto the blocking element.

6. The gate arrangement according to claim 1, wherein
the gate arrangement comprises a blocking element position sensor configured to detect the current position of the movable blocking element, and
the at least one actuator control equipment is configured to adjust the maximum permissible actuating force of the actuator based further on the detected current position of the blocking element and/or the detected force direction.

7. The gate arrangement according to claim 1, wherein
the force detection equipment comprises at least one actuator sensor configured to detect at least one actuator parameter.

8. The gate arrangement according to claim 7, wherein
the actuator sensor is configured to detect a motor current applied to the actuator.

9. The gate arrangement according to claim 6, wherein
the blocking element position sensor is configured to detect a blocking element angle relative to a defined rest position of the blocking element.

10. The gate arrangement according to claim 1, wherein
the gate arrangement comprises at least one brake configured to block a moving of the blocking element, and
the actuator control equipment is configured to control the brake based on the at least one detected force parameter and the at least one detected occupancy status.

11. The gate arrangement according to claim 1, wherein
the gate comprises a further blocking element movable by a further actuator,
the actuator control equipment is configured to control the further actuator in such a way that, if at least one further external force acts onto the further blocking element, the further actuator generates a further actuating force counteracting the further external force up to a further maximum permissible actuating force,
wherein the at least one force detection equipment is configured to detect at least one further force parameter of the acting further external force causing the further actuating force,
wherein the at least one actuator control equipment is configured to independently adjust the further maximum permissible actuating force of the further actuator based on the at least one detected further force parameter and the detected occupancy status.

12. The gate arrangement according to claim 1, wherein
the gate arrangement comprises at least one evaluation equipment configured to determine a gate set behavior based on a detected parameter pattern containing at least the at least one detected force parameter and the at least one detected occupancy status,
wherein the gate set behavior is determined from a plurality of predefined behavior patterns stored in a data memory and assigned to different predefined parameter set ranges,
wherein the actuator control equipment is configured to determine the maximum permissible actuating force based on the determined gate set behavior.

13. The gate arrangement according to claim 12, wherein
the detected parameter pattern contains a validation datum about a valid or invalid validation of an access authorization at the gate.

14. The gate arrangement according to claim 12, wherein
the plurality of predefined behavior patterns comprises at least one gate blocking behavior and one gate release behavior.

15. The gate arrangement according to claim 14, wherein
the predefined gate blocking behavior is assigned a predefined parameter set range containing
no validation datum or an invalid validation datum,
an occupied state at the non-control area side of the blocking element, and
an unoccupied state at the control area side of the blocking element and
at least one detected force parameter from which it can at least be inferred that an external force greater than zero is acting onto the blocking element,
and/or
the predefined gate release behavior is assigned a predefined parameter set range containing
no validation date or an invalid validation date,
a non-occupied state at the non-control area side of the blocking element, and
an occupied state at the control area side of the blocking element and
at least one detected force parameter from which it can at least be deduced that an external force greater than zero is acting onto the blocking element.

16. The gate arrangement according to claim 1, wherein
the actuator control equipment is configured to set the actuating force by controlling a motor current of the actuator with a set motor current value based on the determined gate set behavior.

17. The gate arrangement according to claim 1, wherein
the gate arrangement comprises at least one analysis equipment configured to detect a blocking element of a gate of the gate arrangement that has been moved at least partially into the open position during the closed state,
wherein the occupancy status detection equipment is configured to detect the occupancy status of the gate at the control area side of the blocking element and/or at the non-control area side of the blocking element during the closed state and the at least partially open position,
and
the actuator control equipment is configured to control the actuator such that the blocking element is moved by the actuator into the closed position based on the at least one detected occupancy status,
and/or
the actuator control equipment is configured to control an alarm equipment of the gate arrangement in such a way that an alarm is emitted by the alarm equipment based on the at least one detected occupancy status.

18. The gate arrangement according to claim 1, wherein
the gate arrangement comprises a plurality of gates and at least one gate controller,
the gate controller is configured to jointly control the respective pieces of actuator control equipment of the respective gates if the gate controller determines that a gate release behavior is determined at least almost simultaneously for at least two gates in such a way that a reduced maximum actuating force of the actuators is determined.

19. A method for operating a gate arrangement, wherein the gate arrangement comprises at least one gate having a first gate body and a second gate body arranged adjacent to the first gate body, wherein the first gate body and the second gate body define a passageway between a control area and a non-control area, and having at least one blocking element movable by at least one actuator of the gate between an open position and a closed position, and at least one actuator control equipment configured to control the actuator such that the actuator moves the blocking element into a predefined position, wherein the actuator control equipment is configured to control the actuator such that, if at least one external force acts onto the blocking element, the actuator generates an actuating force counteracting the external force up to a maximum permissible actuating force, wherein the method comprises:
detecting, by at least one occupancy status detection equipment, an occupancy status of the gate at a control area side of the blocking element and/or at a non-control area side of the blocking element,
detecting, by at least one force detection equipment, at least one force parameter causing the actuating force, wherein the actuating force counteracts the acting external force, and
adjusting, by the at least one actuator control equipment, the maximum permissible actuating force of the actuator based on the at least one detected force parameter and the detected occupancy status.

20. A computer program comprising instructions that cause a processor of a gate arrangement to execute and/or control the method according to claim 19.

21. A passenger transport system, comprising
at least one transport vehicle, and
at least one gate arrangement according to claim 1,
wherein the gate arrangement is configured to control access to the transport vehicle.
